(19) United States
(12) Patent Application Publication
(10) Pub. No.: US 2026/0209584 A1
(43) Pub. Date: Jul. 23, 2026

(54) ABRASIVE ARTICLE WITH ECO-FRIENDLY SOLVENT

(71) Applicants: SAINT-GOBAIN ABRASIVES, INC., Worcester, MA (US); SAINT-GOBAIN ABRASIFS, Conflans-Sainte-Honorine (FR)

(72) Inventors: Siwar TRABELSI, Southborough, MA (US); Karen Judith SANDOVAL HERRERA, Reynosa, Tamaulipas (MX); Daniel Eugenio HERNANDEZ, Reynosa, Tamaulipas (MX); Sathanjheri RAVISHANKAR, Shrewsbury, MA (US)

(21) Appl. No.: 19/144,432

(22) PCT Filed: Dec. 28, 2023
(86) PCT No.: PCT/US2023/086293

§ 371 Date: Jun. 27, 2025

Related U.S. Application Data
(60) Provisional application No. 63/477,458, filed on Dec. 28, 2022.

(51) Int. Cl. C09K 3/14

(52) U.S. Cl. CPC C09K 3/1436

(57) ABSTRACT

An eco-friendly abrasive article includes a substrate and an abrasive layer. The abrasive layer can include abrasive particles and a binder. The binder can include an eco-friendly solvent comprising d-limonene; l-limonene; racemic limone; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.

### TECHNICAL FIELD

This disclosure relates, in general, to abrasive articles and in particular, to articles and methods regarding abrasive articles with eco-friendly friendly properties. The abrasive articles possess physical and performance properties that beneficially exceed the state of the art.

### BRIEF DESCRIPTION OF THE DRAWINGS

The present disclosure may be better understood, and its numerous features and advantages made apparent to those skilled in the art by referencing the accompanying drawings.

FIG. 1 includes an image of an abrasive article or abrasive article precursor according to an embodiment.

Skilled artisans appreciate that elements in the figures are illustrated for simplicity and clarity and have not necessarily been drawn to scale. For example, the dimensions of some of the elements in the figures can be exaggerated relative to other elements to help improve understanding of embodiments of the invention. The use of the same reference symbols in different drawings indicates similar or identical items.

### DETAILED DESCRIPTION OF THE PREFERRED EMBODIMENT(S)

The following description, in combination with the figures, is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present), and B is false (or not present), A is false (or not present), and B is true (or present), and both A and B are true (or present).

The use of “a” or “an” is employed to describe elements and components described herein. This is done merely for convenience and to give a general sense of the scope of the invention. This description should be read to include one, or at least one, and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

Embodiments herein relate to coated abrasive articles, or more specifically, nonwoven articles. In particular, embodiments herein relate nonwoven hand tools having improved hand feel and performance. For example, the nonwoven hand tools may have improved mechanical properties, such as peel strength, tensile strength, or any combination thereof, service life, stiffness, or any combination thereof.

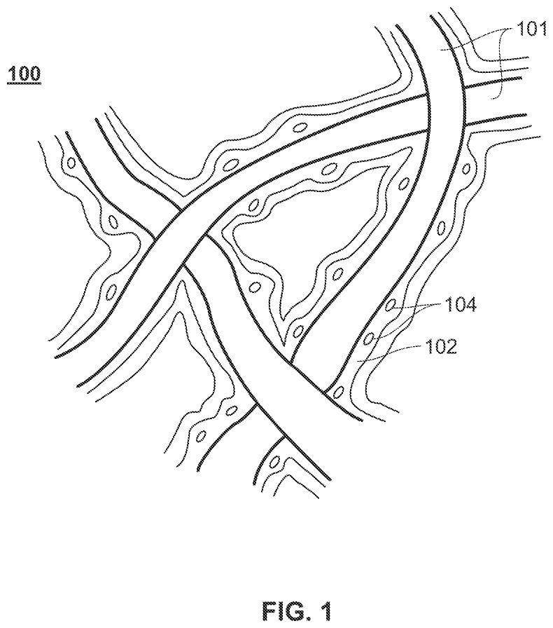

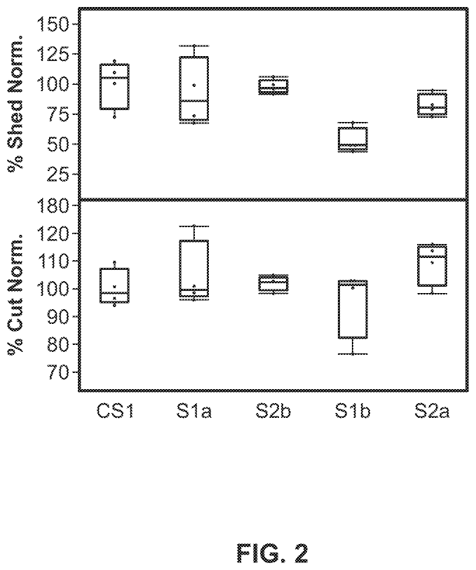

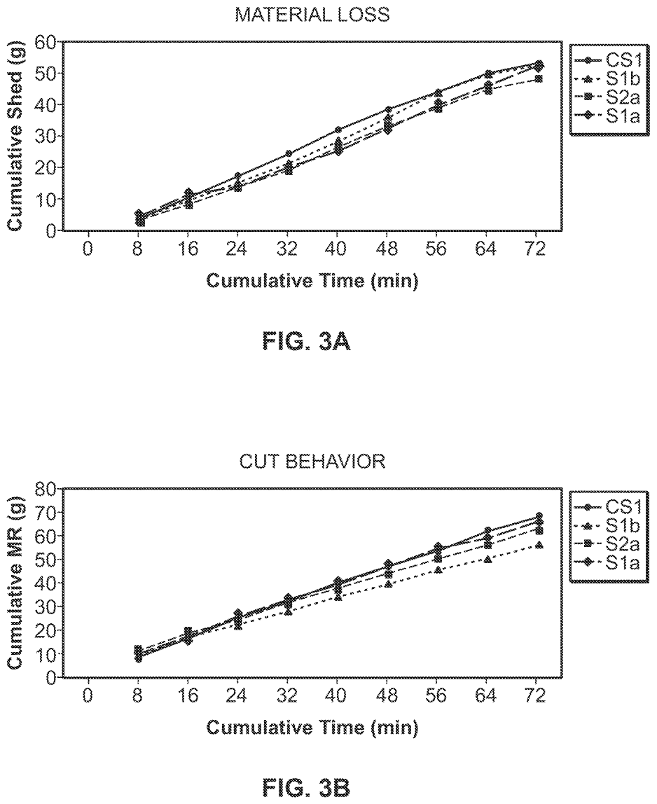

Referring to FIG. 1, an abrasive article, or an abrasive article precursor 100, is illustrated. The abrasive article precursor 100 can include a substrate 101 and an abrasive layer. The abrasive layer can include abrasive particles 104 and a binder 102.

In one embodiment, the substrate may comprise a particular material that may facilitate improved performance and/or manufacturing of the abrasive article. The substrate 101 can be flexible or rigid. The substrate 101 can be made of any number of various materials including those conventionally used as backings in the manufacture of coated abrasives. An exemplary flexible substrate 101 includes a polymeric film (for example, a primed film), such as polyolefin film (e.g., polypropylene including biaxially oriented polypropylene), polyester film (e.g., polyethylene terephthalate), polyamide film, or cellulose ester film; metal foil; mesh; foam (e.g., natural sponge material or polyurethane foam); cloth (e.g., cloth made from fibers or yarns comprising polyester, nylon, silk, cotton, poly-cotton, rayon, or combinations thereof); paper; vulcanized paper; vulcanized rubber; vulcanized fiber; nonwoven materials; a combination thereof; or a treated version thereof. Cloth substrates can be woven or stitch bonded. In particular examples, the substrate is selected from the group consisting of paper, polymer film, cloth (e.g., cotton, poly-cotton, rayon, polyester, poly-nylon), vulcanized rubber, vulcanized fiber, metal foil and a combination thereof. In other examples, the substrate 101 includes polypropylene film or polyethylene terephthalate (PET) film. In an embodiment, the substrate 101 can be a non-woven substrate. In a more particular embodiment, the non-woven substrate 101 can include polymer or nylon fibers.

The substrate can optionally have at least one of a saturant, a presize layer (also called a “front fill layer”), or a backsize layer (also called a “back fill layer”). The purpose of these layers is typically to seal the substrate or to protect yarn or fibers in the substrate. If the substrate is a cloth material, at least one of these layers is typically used. The addition of the presize layer or backsize layer can additionally result in a “smoother” surface on either the front or the back side of the substrate.

The abrasive layer can include abrasive particles 104 disposed on, or dispersed in, a binder 102.

In one embodiment, the abrasive particles can have a particular composition that may facilitate improved manufacturing and/or performance of the abrasive article or abrasive article precursor. Abrasive particles can include essentially single phase inorganic materials, such as alumina, silicon carbide, silica, ceria, and harder, high performance superabrasive particles such as cubic boron nitride and diamond. Additionally, the abrasive particles can include composite particulate materials. Such materials can include aggregates, which can be formed through slurry processing pathways that include removal of the liquid carrier through volatilization or evaporation, leaving behind unfired (“green”) aggregates, which can optionally undergo high temperature treatment (i.e., firing, sintering) to form usable, fired aggregates. Further, the abrasive regions can include engineered abrasives including macrostructures and particular three-dimensional structures.

In an embodiment, the abrasive particles are blended with the binder formulation to form abrasive slurry. Alternatively, the abrasive particles are applied over the binder formulation after the binder formulation is coated on the substrate. Optionally, a functional powder can be applied over the abrasive regions to prevent the abrasive regions from sticking to a patterning tooling. Alternatively, patterns can be formed in the abrasive regions absent the functional powder.

The abrasive particles can be formed of any one of or a combination of abrasive particles, including silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery. For example, the abrasive particles can be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, and a blend thereof. In a particular embodiment, the abrasive particles can include alumina.

The abrasive grain can also have a particular shape. An example of such a shape includes a rod, a triangle, a pyramid, a cone, a solid sphere, a hollow sphere, or the like. Alternatively, the abrasive grain can be randomly shaped.

In an embodiment, the abrasive particles can have an average particle size of not greater than 2000 microns or not greater than about 1500 microns or not greater than about 1000 microns or not greater than about 750 microns or not greater than 500 microns or not greater than 250 microns or not greater than 100 microns. In another embodiment, the abrasive particle size is at least 0.1 microns or at least 1 micron or at least 5 microns or at least 10 microns or at least 25 microns or at least 45 microns or at least 75 microns or at least 100 microns. In another embodiment, the abrasive particles size is from about 0.1 microns to about 2000 microns. The particle size of the abrasive particles is typically specified to be the longest dimension of the abrasive particle. Generally, there is a range distribution of particle sizes. In some instances, the particle size distribution is tightly controlled.

In one embodiment, the binder 102 can have a particular composition that may facilitate improved manufacturing and/or performance of the abrasive article or abrasive article precursor. The composition may also reduce the ecological impact of the article or manufacturing thereof, can be formed of a single polymer or a blend of polymers. The binder composition can be formed from an epoxy composition, acrylic composition, a phenolic composition, a polyurethane composition, a phenolic composition, a polysiloxane composition, or combinations thereof.

The binder composition generally includes a polymer matrix, which binds abrasive particles to the substrate or to a compliant coat, if such a compliant coat is present. Typically, the binder composition is formed of cured binder formulation. In an embodiment, the binder formulation includes a polymer component and a dispersed phase.

The binder formulation can include one or more reaction constituents or polymer constituents for the preparation of a polymer. A polymer constituent can include a monomeric molecule, a polymeric molecule, or a combination thereof. The binder formulation can further comprise components selected from the group consisting of solvents, plasticizers, chain transfer agents, catalysts, stabilizers, dispersants, curing agents, reaction mediators and agents for influencing the fluidity of the dispersion.

The polymer constituents can form thermoplastics or thermosets. By way of example, the polymer constituents can include monomers and resins for the formation of polyurethane, polyurea, polymerized epoxy, polyester, polyimide, polysiloxanes (silicones), polymerized alkyd, styrene-butadiene rubber, acrylonitrile-butadiene rubber, polybutadiene, or, in general, reactive resins for the production of thermoset polymers. Another example includes an acrylate or a methacrylate polymer constituent. The precursor polymer constituents are typically curable organic material (i.e., a polymer monomer or material capable of polymerizing or crosslinking upon exposure to heat or other sources of energy, such as electron beam, ultraviolet light, visible light, etc., or with time upon the addition of a chemical catalyst, moisture, or other agent which cause the polymer to cure or polymerize). A precursor polymer constituent example includes a reactive constituent for the formation of an amino polymer or an aminoplast polymer, such as alkylated urea-formaldehyde polymer, melamine-formaldehyde polymer, and alkylated benzoguanamine-formaldehyde polymer; acrylate polymer including acrylate and methacrylate polymer, alkyl acrylate, acrylated epoxy, acrylated urethane, acrylated polyester, acrylated polyether, vinyl ether, acrylated oil, or acrylated silicone; alkyd polymer such as urethane alkyd polymer; polyester polymer; reactive urethane polymer; phenolic polymer such as resole and novolac polymer; phenolic/latex polymer; epoxy polymer such as bisphenol epoxy polymer; isocyanate; isocyanurate; polysiloxane polymer including alkylalkoxysilane polymer; or reactive vinyl polymer. The binder formulation can include a monomer, an oligomer, a polymer, or a combination thereof. In a particular embodiment, the binder formulation includes monomers of at least two types of polymers that when cured can crosslink. For example, the binder formulation can include epoxy constituents and acrylic constituents that when cured form an epoxy/acrylic polymer.

In an embodiment, the binder can include an eco-friendly solvent. In one embodiment, the eco-friendly solvent can include d-limonene; l-limonene; racemic limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof. In a particular embodiment, the eco-friendly solvent can include d-limonene, l-limonene, racemic limonene; dipentene; or ethyl levulinate. In an embodiment, the eco-friendly solvent can include d-limonene, l-limonene, or a combination thereof. In an embodiment, the eco-friendly solvent can include racemic limonene. In an embodiment, the eco-friendly solvent can include dipentene. In an embodiment, the eco-friendly solvent can include racemic limonene. In an embodiment, the eco-friendly solvent can include ethyl levulinate. In an embodiment, the binder can be essentially free of methyl ethyl ketone or MIBK, or a combination thereof.

In an embodiment, the abrasive layer can include a particular content of eco-friendly solvent that may facilitate improved manufacturing and/or performance of the abrasive article or abrasive article precursor. The eco-friendly solvent may also reduce the ecological impact of the article or manufacturing thereof. In an embodiment, the abrasive layer can include at least 5 wt % or at least 6 wt % eco-friendly solvent or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt % or at least 27 wt % or at least 28 wt % or at least 29 wt % or at least 30 wt % or at least 31 wt % or at least 32 wt % or at least 33 wt % or at least 34 wt % or at least 35 wt % or at least 36 wt % or at least 37 wt % or at least 38 wt % or at least 39 wt % or at least 40 wt % or at least 41 wt % or at least 42 wt % or at least 43 wt % or at least 44 wt % or at least 45 wt %. In an embodiment the abrasive layer can include not greater than 50 wt % or not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt % or not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 15 wt %. It will be appreciated that the eco-friendly solvent content can be between any of the minimum or maximum values noted above.

In one embodiment, the eco-friendly solvent can have a particular boiling point that may facilitate improved manufacturing and/or performance of the abrasive article or abrasive article precursor. The eco-friendly solvent may also reduce the ecological impact of the article or manufacturing thereof. In one embodiment the eco-friendly solvent can have a boiling point of at least 300° F. or at least 305° F. or at least 310° F. or at least 315° F. or at least 320° F. or at least 325° F. or at least 330° F. or at least 335° F. or at least 340° F. In one embodiment the eco solvent can have a boiling point of less than 480° F. or less than 470° F. or less than 460° F. or less than 450° F. or less than 440° F. or less than 430° F. or less than 420° F. or less than 410° F. or less than 400° F. or less than 390° F. or less than 380° F. or less than 370° F. or less than 360° F. or less than 350° F. It will be appreciated that the boiling point of the eco-friendly solvent may be between any of the minimum or maximum values noted above, including for example, but not limited to at least 310° F. and not greater than 470° F. or at least 340° F. and less than 350° F.

In one embodiment, the eco-friendly solvent can have a particular flash point that may facilitate improved manufacturing and/or performance of the abrasive article or abrasive article precursor. The eco-friendly solvent may also reduce the ecological impact of the article or manufacturing thereof. In one embodiment the eco-friendly solvent can have a flash point of at least 100° F. or at least 105° F. or at least 110° F. or at least 115° F. In one embodiment the eco solvent can have a flash point of less than 300° F. or less than 275° F. or less than 250° F. or less than 225° F. or less than 200° F. or less than 175° F. or less than 150° F. or less than 125° F. It will be appreciated that the boiling point of the eco-friendly solvent may be between any of the minimum or maximum values noted above, including for example, but not limited to at least 105° F. and not greater than 250° F. or at least 110° F. and less than 125° F.

In an embodiment, the eco-friendly solvent can have a particular blue NFPA 704 safety square health hazard rating. In an embodiment the blue NFPA 704 safety square health hazard rating of less than or equal to 2, or less than or equal to 1.

In an embodiment, the eco-friendly solvent can have a particular red NFPA 704 safety square fire hazard rating. In an embodiment the red NFPA 704 safety square fire hazard rating of less than or equal to 2.

In an embodiment, the eco-friendly solvent can have a particular yellow NFPA 704 safety square reactivity hazard rating. In an embodiment the yellow NFPA 704 safety square reactivity hazard rating of less than or equal to 0.

The abrasive article can include a presize coat disposed on the substrate. The presize coat can be the same as or different from the polymer binder composition used to form the binder 102 of the abrasive layer. The presize coat can comprise any conventional compositions known in the art that can be used as a presize coat. The presize coat can include one or more additives or abrasive particles. The presize coat can be a part of the abrasive layer or separate from the abrasive layer.

The abrasive article can include a make coat disposed on the substrate. The make coat can be the same as or different from the polymer binder composition used to form the binder 102 of the abrasive layer. The make coat can comprise any conventional compositions known in the art that can be used as a make coat. The presize coat can include one or more additives or abrasive particles. The make coat can be a part of the abrasive layer or separate from the abrasive layer.

The abrasive article can include a size coat disposed on the substrate. The size coat can be the same as or different from the polymer binder composition used to form the binder 102 of the abrasive layer. The size coat can comprise any conventional compositions known in the art that can be used as a size coat. The presize coat can include one or more additives or abrasive particles. The size coat can be a part of the abrasive layer or separate from the abrasive layer.

The abrasive article can include a supersize coat disposed on the substrate. The supersize coat can be the same as or different from the polymer binder composition used to form the binder 102 of the abrasive layer. The supersize coat can comprise any conventional compositions known in the art that can be used as a supersize coat. The presize coat can include one or more additives or abrasive particles. The supersize coat can be a part of the abrasive layer or separate from the abrasive layer.

The presize coat, make coat, size coat, supersize coat, or abrasive layer can include one or more additives. Suitable additives can include grinding aids, fibers, lubricants, wetting agents, thixotropic materials, surfactants, thickening agents, pigments, dyes, antistatic agents, coupling agents, plasticizers, suspending agents, pH modifiers, adhesion promoters, lubricants, bactericides, fungicides, flame retardants, degassing agents, anti-dusting agents, dual function materials, initiators, chain transfer agents, stabilizers, dispersants, reaction mediators, colorants, and defoamers. The amounts of these additive materials can be selected to provide the properties desired. These optional additives can be present in any part of the overall system of the coated abrasive product according to embodiments of the present disclosure. Suitable grinding aids can be inorganic based; such as halide salts, for example, cryolite, wollastonite, and potassium fluoroborate; or organic based, such as sodium lauryl sulphate, or chlorinated waxes, such as polyvinyl chloride. In an embodiment, the grinding aid can be an environmentally sustainable material.

### EMBODIMENTS

Embodiment 1. An abrasive article precursor comprising:
a substrate:
an abrasive layer comprising abrasive particles and a binder;
wherein the abrasive layer comprises 5-50 wt % of, an eco-solvent;
wherein the eco-solvent comprises:
   d-limonene; l-limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.
Embodiment 2. The abrasive article precursor of embodiment 1, wherein the substrate comprises a polymeric film (for example, a primed film), such as polyolefin film (e.g., polypropylene including biaxially oriented polypropylene), polyester film (e.g., polyethylene terephthalate), polyamide film, or cellulose ester film; metal foil; mesh; foam (e.g., natural sponge material or polyurethane foam); cloth (e.g., cloth made from fibers or yarns comprising polyester, nylon, silk, cotton, poly-cotton, rayon, or combinations thereof); paper; vulcanized paper; vulcanized rubber; vulcanized fiber; nonwoven materials; a combination thereof; or a treated version thereof.
Embodiment 3. The abrasive article precursor of embodiment 1, wherein the substrate comprises a nonwoven material.
Embodiment 4. The abrasive article precursor of embodiment 1, wherein the substrate comprises nylon fibers.
Embodiment 5. The abrasive article precursor of embodiment 1, wherein the abrasive particles comprise silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery. For example, the abrasive particles can be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, shaped abrasive particles, or a blend thereof.
Embodiment 6. The abrasive article precursor of embodiment 1, wherein the abrasive particles comprise alumina.
Embodiment 7. The abrasive article precursor of embodiment 1, wherein the abrasive particles comprise an average particle size of not greater than 2000 microns or not greater than about 1500 microns or not greater than about 1000 microns or not greater than about 750 microns or not greater than 500 microns or not greater than 250 microns or not greater than 100 microns or at least 0.1 microns or at least 1 microns or at least 5 microns or at least 10 microns or at least 25 microns or at least 45 microns or at least 75 microns or at least 100 microns.
Embodiment 8. The abrasive article precursor of embodiment 1, wherein the binder comprises an epoxy composition, acrylic composition, a phenolic composition, a polyurethane composition, a phenolic composition, a polysiloxane composition, or combinations thereof.
Embodiment 9. The abrasive article precursor of embodiment 1, wherein the eco-solvent comprises ethyl levulinate, d-limonene, l-limonene, dipentene, or a combination thereof.
Embodiment 10. The abrasive article precursor of embodiment 1, wherein the eco-solvent comprises ethyl levulinate, dipentene, or a combination thereof.
Embodiment 11. The abrasive article precursor of embodiment 1, wherein the eco-solvent comprises d-limonene and l-limonene.
Embodiment 12. The abrasive article precursor of embodiment 1, wherein the eco-solvent comprises racemic limonene.
Embodiment 13. The abrasive article precursor of embodiment 1, wherein the eco-solvent comprises dipentene.
Embodiment 14. The abrasive article precursor of embodiment 1, wherein the eco-solvent comprises ethyl levulinate.
Embodiment 15. The abrasive article precursor of embodiment 1, wherein the eco-solvent comprises a boiling point of at least 300° F. or at least 305° F. or at least 310° F. or at least 315° F. or at least 320° F. or at least 325° F. or at least 330° F. or at least 335° F. or at least 340° F.
Embodiment 16. The abrasive article precursor of embodiment 1, wherein the eco-solvent comprises a boiling point of less than 480° F. or less than 470° F. or less than 460° F. or less than 450° F. or less than 440° F. or less than 430° F. or less than 420° F. or less than 10° F. or less than 400° F. or less than 390° F. or less than 380° F. or less than 370° F. or less than 360° F. or less than 350° F.
Embodiment 17. The abrasive article precursor of embodiment 1, wherein the eco-solvent comprises a flash point of at least 100° F. or at least 105° F. or at least 110° F. or at least 115° F.
Embodiment 18. The abrasive article precursor of embodiment 1, wherein the eco-solvent comprises a flash point of less than 300° F. or less than 275° F. or less than 250° F. or less than 225° F. or less than 200° F. or less than 175° F. or less than 150° F. or less than 125° F.
Embodiment 19. The abrasive article precursor of embodiment 1, wherein the eco-solvent comprises a blue NFPA 704 safety square label health hazard rating of less than or equal to 2, or less than or equal to 1.
Embodiment 20. The abrasive article precursor of embodiment 1, wherein the eco-solvent comprises a red NFPA 704 safety square label health hazard rating of less than or equal to 2.
Embodiment 21. The abrasive article precursor of embodiment 1, wherein the eco-solvent comprises a yellow NFPA 704 safety square label health hazard rating of 0.
Embodiment 22. The abrasive article precursor of embodiment 1, wherein the binder is essentially free of methyl ethyl ketone.
Embodiment 23. The abrasive article precursor of embodiment 1, wherein the binder is essentially free of MIBK.
Embodiment 24. The abrasive article precursor of embodiment 1, wherein the abrasive layer comprises at least 6 wt % eco-solvent or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt % or at least 27 wt % or at least 28 wt % or at least 29 wt % or at least 30 wt % or at least 31 wt % or at least 32 wt % or at least 33 wt % or at least 34 wt % or at least 35 wt % or at least 36 wt % or at least 37 wt % or at least 38 wt % or at least 39 wt % or at least 40 wt % or at least 41 wt % or at least 42 wt % or at least 43 wt % or at least 44 wt % or at least 45 wt %.
Embodiment 25. The abrasive article precursor of embodiment 1, wherein the abrasive layer comprises not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt % or not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 15 wt %.
Embodiment 26. The abrasive article precursor of embodiment 1, wherein the abrasive layer further comprises an additive comprising grinding aids, fibers, lubricants, wetting agents, thixotropic materials, surfactants, thickening agents, pigments, dyes, antistatic agents, coupling agents, plasticizers, suspending agents, pH modifiers, adhesion promoters, lubricants, bactericides, fungicides, flame retardants, degassing agents, anti-dusting agents, dual function materials, initiators, chain transfer agents, stabilizers, dispersants, reaction mediators, colorants, and defoamers or a combination thereof.
Embodiment 27. The abrasive article precursor of embodiment 1, wherein the abrasive article precursor further comprises a presize coat.
Embodiment 28. The abrasive article precursor of embodiment 27, wherein the presize coat comprises an epoxy composition, acrylic composition, a phenolic composition, a polyurethane composition, a phenolic composition, a polysiloxane composition, or combinations thereof.
Embodiment 29. The abrasive article precursor of embodiment 27, wherein the presize coat comprises abrasive particles or at least one additive.
Embodiment 30. The abrasive article precursor of embodiment 27, wherein presize coat is a part of the abrasive layer or separate from the abrasive layer.
Embodiment 31. The abrasive article precursor of embodiment 1, wherein the abrasive article precursor further comprises a make coat.
Embodiment 32. The abrasive article precursor of embodiment 31, wherein the make coat comprises an epoxy composition, acrylic composition, a phenolic composition, a polyurethane composition, a phenolic composition, a polysiloxane composition, or combinations thereof.
Embodiment 33. The abrasive article precursor of embodiment 31, wherein the make coat comprises abrasive particles or at least one additive.
Embodiment 34. The abrasive article precursor of embodiment 31, wherein make layer is a part of the abrasive layer or separate from the abrasive layer.
Embodiment 35. The abrasive article precursor of embodiment 1, wherein the abrasive article precursor further comprises a size coat.
Embodiment 36. The abrasive article precursor of embodiment 35, wherein the size coat comprises an epoxy composition, acrylic composition, a phenolic composition, a polyurethane composition, a phenolic composition, a polysiloxane composition, or combinations thereof.
Embodiment 37. The abrasive article precursor of embodiment 35, wherein the size coat comprises abrasive particles or at least one additive.
Embodiment 38. The abrasive article precursor of embodiment 35, wherein size coat is a part of the abrasive layer or separate from the abrasive layer.
Embodiment 39. The abrasive article precursor of embodiment 1, wherein the abrasive article precursor further comprises a supersize coat.
Embodiment 40. The abrasive article precursor of embodiment 39, wherein the supersize coat comprises an epoxy composition, acrylic composition, a phenolic composition, a polyurethane composition, a phenolic composition, a polysiloxane composition, or combinations thereof.
Embodiment 41. The abrasive article precursor of embodiment 39, wherein the supersize coat comprises abrasive particles or at least one additive.
Embodiment 42. The abrasive article precursor of embodiment 39, wherein supersize coat is a part of the abrasive layer or separate from the abrasive layer.
Embodiment 43. An abrasive article comprising:
a substrate:
an abrasive layer comprising abrasive particles and a binder;
wherein the abrasive layer comprises an eco-solvent;
wherein the eco-solvent comprises:
d-limonene; l-limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.
Embodiment 44. The abrasive article of embodiment 43, wherein the substrate comprises a polymeric film (for example, a primed film), such as polyolefin film (e.g., polypropylene including biaxially oriented polypropylene), polyester film (e.g., polyethylene terephthalate), polyamide film, or cellulose ester film; metal foil; mesh; foam (e.g., natural sponge material or polyurethane foam); cloth (e.g., cloth made from fibers or yarns comprising polyester, nylon, silk, cotton, poly-cotton, rayon, or combinations thereof); paper; vulcanized paper; vulcanized rubber; vulcanized fiber; nonwoven materials; a combination thereof; or a treated version thereof.
Embodiment 45. The abrasive article of embodiment 43, wherein the substrate comprises a nonwoven material.
Embodiment 46. The abrasive article of embodiment 43, wherein the substrate comprises nylon fibers.
Embodiment 47. The abrasive article of embodiment 43, wherein the abrasive particles comprise silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery. For example, the abrasive particles can be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, shaped abrasive particles, or a blend thereof.
Embodiment 48. The abrasive article of embodiment 43, wherein the abrasive particles comprise alumina.
Embodiment 49. The abrasive article of embodiment 43, wherein the abrasive particles comprise an average particle size of not greater than 2000 microns or not greater than about 1500 microns or not greater than about 1000 microns or not greater than about 750 microns or not greater than 500 microns or not greater than 250 microns or not greater than 100 microns or at least 0.1 microns or at least 1 microns or at least 5 microns or at least 10 microns or at least 25 microns or at least 45 microns or at least 75 microns or at least 100 microns.
Embodiment 50. The abrasive article of embodiment 43, wherein the binder comprises an epoxy composition, acrylic composition, a phenolic composition, a polyurethane composition, a phenolic composition, a polysiloxane composition, or combinations thereof.
Embodiment 51. The abrasive article of embodiment 43, wherein the eco-solvent comprises ethyl levulinate, d-limonene, l-limonene, dipentene, or a combination thereof.
Embodiment 52. The abrasive article of embodiment 43, wherein the eco-solvent comprises ethyl levulinate, dipentene, or a combination thereof.
Embodiment 53. The abrasive article of embodiment 43, wherein the eco-solvent comprises d-limonene and l-limonene.
Embodiment 54. The abrasive article of embodiment 43, wherein the eco-solvent comprises racemic limonene.
Embodiment 55. The abrasive article of embodiment 43, wherein the eco-solvent comprises dipentene.
Embodiment 56. The abrasive article of embodiment 43, wherein the eco-solvent comprises ethyl-levulinate.
Embodiment 57. The abrasive article of embodiment 43, wherein the eco-friendly solvent comprises a boiling point of at least 300° F. or at least 305° F. or at least 310° F. or at least 315° F. or at least 320° F. or at least 325° F. or at least 330° F. or at least 335° F. or at least 340° F.
Embodiment 58. The abrasive article of embodiment 43, wherein the eco-friendly solvent comprises a boiling point of less than 480° F. or less than 470° F. or less than 460° F. or less than 450° F. or less than 440° F. or less than 430° F. or less than 420° F. or less than 410° F. or less than 400° F. or less than 390° F. or less than 380° F. or less than 370° F. or less than 360° F. or less than 350° F.
Embodiment 59. The abrasive article of embodiment 43, wherein the eco-friendly solvent comprises a flash point of at least 100° F. or at least 105° F. or at least 110° F. or at least 115° F.
Embodiment 60. The abrasive article of embodiment 43, wherein the eco-friendly solvent comprises a flash point of less than 300° F. or less than 275° F. or less than 250° F. or less than 225° F. or less than 200° F. or less than 175° F. or less than 150° F. or less than 125° F.
Embodiment 61. The abrasive article of embodiment 43, wherein the eco-friendly solvent comprises a blue NFPA 704 safety square label health hazard rating of less than or equal to 2, or less than or equal to 1.
Embodiment 62. The abrasive article of embodiment 43, wherein the eco-friendly solvent comprises a red NFPA 704 safety square fire hazard rating of less than or equal to 2.
Embodiment 63. The abrasive article of embodiment 43, wherein the eco-friendly solvent comprises a yellow NFPA 704 safety square reactivity hazard rating of 0.
Embodiment 64. The abrasive article of embodiment 43, wherein the binder is essentially free of methyl ethyl ketone.
Embodiment 65. The abrasive article of embodiment 43, wherein the binder is essentially free of MIBK.
Embodiment 66. The abrasive article of embodiment 43, wherein the abrasive layer further comprises an additive comprising grinding aids, fibers, lubricants, wetting agents, thixotropic materials, surfactants, thickening agents, pigments, dyes, antistatic agents, coupling agents, plasticizers, suspending agents, pH modifiers, adhesion promoters, lubricants, bactericides, fungicides, flame retardants, degassing agents, anti-dusting agents, dual function materials, initiators, chain transfer agents, stabilizers, dispersants, reaction mediators, colorants, and defoamers or a combination thereof.
Embodiment 67. The abrasive article of embodiment 43, wherein the abrasive article precursor further comprises a presize coat.
Embodiment 68. The abrasive article of embodiment 27, wherein the presize coat comprises an epoxy composition, acrylic composition, a phenolic composition, a polyurethane composition, a phenolic composition, a polysiloxane composition, or combinations thereof.
Embodiment 69. The abrasive article of embodiment 27, wherein the presize coat comprises abrasive particles or at least one additive.
Embodiment 70. The abrasive article of embodiment 27, wherein presize coat is a part of the abrasive layer or separate from the abrasive layer.
Embodiment 71. The abrasive article of embodiment 43, wherein the abrasive article precursor further comprises a make coat.
Embodiment 72. The abrasive article of embodiment 71, wherein the make coat comprises an epoxy composition, acrylic composition, a phenolic composition, a polyurethane composition, a phenolic composition, a polysiloxane composition, or combinations thereof.
Embodiment 73. The abrasive article of embodiment 71, wherein the make coat comprises abrasive particles or at least one additive.
Embodiment 74. The abrasive article of embodiment 71, wherein make coat is a part of the abrasive layer or separate from the abrasive layer.
Embodiment 75. The abrasive article of embodiment 43, wherein the abrasive article precursor further comprises a size coat.
Embodiment 76. The abrasive article of embodiment 75, wherein the size coat comprises an epoxy composition, acrylic composition, a phenolic composition, a polyurethane composition, a phenolic composition, a polysiloxane composition, or combinations thereof.
Embodiment 77. The abrasive article of embodiment 75, wherein the size coat comprises abrasive particles or at least one additive.
Embodiment 78. The abrasive article of embodiment 75, wherein size coat is a part of the abrasive layer or separate from the abrasive layer.
Embodiment 79. The abrasive article of embodiment 43, wherein the abrasive article precursor further comprises a supersize coat.
Embodiment 80. The abrasive article of embodiment 79, wherein the supersize coat comprises an epoxy composition, acrylic composition, a phenolic composition, a polyurethane composition, a phenolic composition, a polysiloxane composition, or combinations thereof.
Embodiment 81. The abrasive article of embodiment 79, wherein the supersize coat comprises abrasive particles or at least one additive.
Embodiment 82. The abrasive article of embodiment 79, wherein supersize coat is a part of the abrasive layer or separate from the abrasive layer.
Embodiment 83. A method of using the abrasive article of any one of embodiments 43-82 to grind or polish a workpiece.
Embodiment 84. A method of making an abrasive article comprising:
providing a substrate:
depositing an abrasive layer precursor over the substrate, the abrasive layer comprising abrasive particles and a binder; and curing the abrasive layer precursor to form an abrasive layer, wherein the abrasive layer precursor comprises 5-50 wt % of, an eco-solvent; wherein the eco-solvent comprises:
d-limonene; l-limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.
Embodiment 85. The method of embodiment 84, wherein the substrate comprises a polymeric film (for example, a primed film), such as polyolefin film (e.g., polypropylene including biaxially oriented polypropylene), polyester film (e.g., polyethylene terephthalate), polyamide film, or cellulose ester film; metal foil; mesh; foam (e.g., natural sponge material or polyurethane foam); cloth (e.g., cloth made from fibers or yarns comprising polyester, nylon, silk, cotton, poly-cotton, rayon, or combinations thereof); paper; vulcanized paper; vulcanized rubber; vulcanized fiber; nonwoven materials; a combination thereof; or a treated version thereof.
Embodiment 86. The method of embodiment 84, wherein the substrate comprises a nonwoven material.
Embodiment 87. The method of embodiment 84, wherein the substrate comprises nylon fibers.
Embodiment 88. The method of embodiment 84, wherein the abrasive particles comprise silica, alumina (fused or sintered), zirconia, zirconia/alumina oxides, silicon carbide, garnet, diamond, cubic boron nitride, silicon nitride, ceria, titanium dioxide, titanium diboride, boron carbide, tin oxide, tungsten carbide, titanium carbide, iron oxide, chromia, flint, emery. For example, the abrasive particles can be selected from a group consisting of silica, alumina, zirconia, silicon carbide, silicon nitride, boron nitride, garnet, diamond, co-fused alumina zirconia, ceria, titanium diboride, boron carbide, flint, emery, alumina nitride, shaped abrasive particles, or a blend thereof.
Embodiment 89. The method of embodiment 84, wherein the abrasive particles comprise alumina.
Embodiment 90. The method of embodiment 84, wherein the abrasive particles comprise an average particle size of not greater than 2000 microns or not greater than about 1500 microns or not greater than about 1000 microns or not greater than about 750 microns or not greater than 500 microns or not greater than 250 microns or not greater than 100 microns or at least 0.1 microns or at least 1 microns or at least 5 microns or at least 10 microns or at least 25 microns or at least 45 microns or at least 75 microns or at least 100 microns.
Embodiment 91. The method of embodiment 84, wherein the binder comprises an epoxy composition, acrylic composition, a phenolic composition, a polyurethane composition, a phenolic composition, a polysiloxane composition, or combinations thereof.
Embodiment 92. The method of embodiment 84, wherein the eco-solvent comprises ethyl levulinate, d-limonene, l-limonene, dipentene, or a combination thereof.
Embodiment 93. The method of embodiment 84, wherein the eco-solvent comprises ethyl levulinate, dipentene, or a combination thereof.
Embodiment 94. The method of embodiment 84, wherein the eco-solvent comprises d-limonene and l-limonene.
Embodiment 95. The method of embodiment 84, wherein the eco-solvent comprises racemic limonene.
Embodiment 96. The method of embodiment 84, wherein the eco-solvent comprises dipentene.
Embodiment 97. The method of embodiment 84, wherein the eco-solvent comprises ethyl levulinate.
Embodiment 98. The method of embodiment 84, wherein the eco-solvent comprises a boiling point of at least 300° F. or at least 305° F. or at least 310° F. or at least 315° F. or at least 320° F. or at least 325° F. or at least 330° F. or at least 335° F. or at least 340° F.
Embodiment 99. The method of embodiment 84, wherein the eco-solvent comprises a boiling point of less than 480° F. or less than 470° F. or less than 460° F. or less than 450° F. or less than 440° F. or less than 430° F. or less than 420° F. or less than 10° F. or less than 400° F. or less than 390° F. or less than 380° F. or less than 370° F. or less than 360° F. or less than 350° F.
Embodiment 100. The method of embodiment 84, wherein the eco-solvent comprises a flash point of at least 100° F. or at least 105° F. or at least 110° F. or at least 115° F.
Embodiment 101. The method of embodiment 84, wherein the eco-solvent comprises a flash point of less than 300° F. or less than 275° F. or less than 250° F. or less than 225° F. or less than 200° F. or less than 175° F. or less than 150° F. or less than 125° F. Embodiment 102. The method of embodiment 84, wherein the eco-solvent comprises a blue NFPA 704 safety square label health hazard rating of less than or equal to 2, or less than or equal to 1.
Embodiment 103. The method of embodiment 84, wherein the eco-solvent comprises a red NFPA 704 safety square label health hazard rating of less than or equal to 2.
Embodiment 104. The method of embodiment 84, wherein the eco-solvent comprises a yellow NFPA 704 safety square label health hazard rating of 0.
Embodiment 105. The method of embodiment 84, wherein the binder is essentially free of methyl ethyl ketone.
Embodiment 106. The method of embodiment 84, wherein the binder is essentially free of MIBK.
Embodiment 107. The method of embodiment 84, wherein the abrasive layer precursor comprises at least 6 wt % eco-solvent or at least 7 wt % or at least 8 wt % or at least 9 wt % or at least 10 wt % or at least 11 wt % or at least 12 wt % or at least 13 wt % or at least 14 wt % or at least 15 wt % or at least 16 wt % or at least 17 wt % or at least 18 wt % or at least 19 wt % or at least 20 wt % or at least 21 wt % or at least 22 wt % or at least 23 wt % or at least 24 wt % or at least 25 wt % or at least 26 wt % or at least 27 wt % or at least 28 wt % or at least 29 wt % or at least 30 wt % or at least 31 wt % or at least 32 wt % or at least 33 wt % or at least 34 wt % or at least 35 wt % or at least 36 wt % or at least 37 wt % or at least 38 wt % or at least 39 wt % or at least 40 wt % or at least 41 wt % or at least 42 wt % or at least 43 wt % or at least 44 wt % or at least 45 wt %.
Embodiment 108. The method of embodiment 84, wherein the abrasive layer precursor comprises not greater than 49 wt % or not greater than 48 wt % or not greater than 47 wt % or not greater than 46 wt % or not greater than 45 wt % or not greater than 44 wt % or not greater than 43 wt % or not greater than 42 wt % or not greater than 41 wt % or not greater than 40 wt % or not greater than 39 wt % or not greater than 38 wt % or not greater than 37 wt % or not greater than 36 wt % or not greater than 35 wt % or not greater than 34 wt % or not greater than 33 wt % or not greater than 32 wt % or not greater than 31 wt % or not greater than 30 wt % or not greater than 29 wt % or not greater than 28 wt % or not greater than 27 wt % or not greater than 26 wt % or not greater than 25 wt % or not greater than 24 wt % or not greater than 23 wt % or not greater than 22 wt % or not greater than 21 wt % or not greater than 20 wt % or not greater than 19 wt % or not greater than 18 wt % or not greater than 17 wt % or not greater than 16 wt % or not greater than 15 wt %.
Embodiment 109. The method of embodiment 84, wherein the abrasive layer further comprises an additive comprising grinding aids, fibers, lubricants, wetting agents, thixotropic materials, surfactants, thickening agents, pigments, dyes, antistatic agents, coupling agents, plasticizers, suspending agents, pH modifiers, adhesion promoters, lubricants, bactericides, fungicides, flame retardants, degassing agents, anti-dusting agents, dual function materials, initiators, chain transfer agents, stabilizers, dispersants, reaction mediators, colorants, and defoamers or a combination thereof.
Embodiment 110. The method of embodiment 84, further comprising depositing a presize coat.
Embodiment 111. The method of embodiment 110, further comprising curing the presize coat.
Embodiment 111. The method of embodiment 110, wherein the presize coat comprises an epoxy composition, acrylic composition, a phenolic composition, a polyurethane composition, a phenolic composition, a polysiloxane composition, or combinations thereof.
Embodiment 112. The method of embodiment 110, wherein the presize coat comprises abrasive particles or at least one additive.
Embodiment 113. The method of embodiment 110, wherein presize coat is a part of the abrasive layer or separate from the abrasive layer.
Embodiment 114. The method of embodiment 84, further comprising depositing a make coat.
Embodiment 115. The method of embodiment 114, wherein the make coat comprises an epoxy composition, acrylic composition, a phenolic composition, a polyurethane composition, a phenolic composition, a polysiloxane composition, or combinations thereof.
Embodiment 116. The method of embodiment 114, wherein the make coat comprises abrasive particles or at least one additive.
Embodiment 117. The method of embodiment 114, wherein make coat is a part of the abrasive layer or separate from the abrasive layer.
Embodiment 118. The method of embodiment 84, further comprising depositing a size coat.
Embodiment 119. The method of embodiment 118, wherein the size coat comprises an epoxy composition, acrylic composition, a phenolic composition, a polyurethane composition, a phenolic composition, a polysiloxane composition, or combinations thereof. Embodiment 120. The method of embodiment 118, wherein the size coat comprises abrasive particles or at least one additive.
Embodiment 121. The method of embodiment 118, wherein size coat is a part of the abrasive layer or separate from the abrasive layer.
Embodiment 122. The method of embodiment 84, further comprising depositing a supersize coat.
Embodiment 123. The method of embodiment 122, wherein the supersize coat comprises an epoxy composition, acrylic composition, a phenolic composition, a polyurethane composition, a phenolic composition, a polysiloxane composition, or combinations thereof.
Embodiment 124. The method of embodiment 122, wherein the supersize coat comprises abrasive particles or at least one additive.
Embodiment 125. The method of embodiment 122, wherein supersize coat is a part of the abrasive layer or separate from the abrasive layer.

### EXAMPLES

### Example 1

Samples 1a, 1b, 2a, 2b, and CS1 were prepared according to Table 1, and the procedure outlined below.

TABLE 1

| | | |
|---|---|---|
| Sample 1a | Sample 2a | Sample |
| and 1b | and 2b | CS1 |

Substrate

| | | | |
|---|---|---|---|
| 60 den. Nylon w/staple | 35-45% | 35-45% | 35-45% |
| length 1.5 inches | | | |
| 40 den. Nylon w/staple | 55-65% | 55-65% | 55-65% |
| length 2.0 inches | | | |

Substrate Coating

| | | | |
|---|---|---|---|
| Water | 58-62% | 58-62% | 58-62% |
| Melamine resin | 1-2% | 1-2% | 1-2% |
| Triton 100X | 0.1-0.5% | 0.1-0.5% | 0.1-0.5% |
| Hycar 26318 | 38-40% | 38-40% | 38-40% |

Pre-size

| | | | |
|---|---|---|---|
| BPT-95A (Polyurethane | 28-32% | 28-38% | 34-38% |
| resin) | | | |
| Silane coated 100 ANSI | 35-45% | 35-50% | 40-50% |
| Grade Aluminum oxide | | | |
| Ethacure EC-102 | 3-5% | 3-5% | 3-5% |
| Ethyl Levulinate | 0% | 7-24% | 0% |
| Dipentene | 18-24% | 0% | 0% |
| MIBK | 0% | 0% | 7-9% |
| Polarlink 5R | 3-4% | 3-4% | 3-5% |
| Lithium Stearate | 0.5-2% | 0.5-2% | 0.5-2% |
| Colorant | 1-2% | 1-2% | 1-2% |
| Nopco (Anti-foaming | 0.1-0.5% | 0.1-0.5% | 0.1-0.5% |
| agent) | | | |
| Dovernox 76 | 0.05-0.2% | 0.05-0.2% | 0.05-0.2% |
| (antioxidant) | | | |
| Oleic acid(catalyzer) | <0.1% | <0.1% | <0.1% |
| Dabco TMR (catalyzer) | <0.05% | <0.05% | <0.05% |

Size

| | | | |
|---|---|---|---|
| BPT-60D (Polyurethane | 37-40% | 37-40% | 37-40% |
| resin) | | | |
| Silane coated 100 ANSI | 35-40% | 35-40% | 35-40% |
| Grade Aluminum oxide | | | |
| Ethacure EC-102 | 4-6% | 4-6% | 4-6% |
| Ethyl Levulinate | 0% | 10-15% | 0% |
| Dipentene | 10-15% | 0% | 0% |
| MIBK | 0% | 0% | 10-15% |
| Polarlink 5R | 3-5% | 3-5% | 3-5% |
| Lithium Stearate | 0.5-2% | 0.5-2% | 0.5-2% |
| Colorant | 1-2% | 1-2% | 1-2% |
| Nopco (Anti-foaming | 0.1-0.5% | 0.1-0.5% | 0.1-0.5% |
| agent) | | | |
| Dovernox 76 | 0.05-0.2% | 0.05-0.2% | 0.05-0.2% |
| (antioxidant) | | | |
| Oleic acid(catalyzer) | <0.1% | <0.1% | <0.1% |
| Dabco TMR (catalyzer) | <0.05% | <0.05% | <0.05% |

A fiber blend having a weight of about 350-360 g/m² was prepared having the composition in Table 1. The fiber blend was then needle punched in a needle loom to form a non-woven web. The substrate coating having the composition outlined in Table 1 was then sprayed on a first side of the non-woven web and then cured. Then, the opposite side of the nonwoven web was sprayed and cured resulting in a non-woven substrate with a weight of about 444 g/m² a width of about 1.42 m and a thickness of about 1.5 cm.

The non-woven web in samples 1, 2 and CS1 are cut into sheets of 46×46 cm and saturated by a dip and squeeze process with the pre-size coating composition outlined above in Table 1. Abrasive grains of aluminum oxide at an average grain size of 100 ANSI grade are dropped by gravity on both sides of the saturated non-woven webs at about 163 g/m². Samples 1a, 2a, and CS1 were cured in an electrical batch oven for 12 minutes at 325° F. while samples 1b and 2b were cured for 20 minutes at the same temperature in the same oven. The presize coated samples 1 and CS1 have a thickness of 1.51 cm, and a weight of about 1.38 kg/m².

The presize coated samples 1, 2 and CS1 were saturated by a dip and squeeze process with the size coating composition outlined above in Table 1. Samples 1a, 2a, and CS1 were cured in an electrical batch oven for 12 minutes at 325° F. while samples 1b and 2b were cured for 20 minutes at the same temperature in the same oven, size coated samples 1 and CS1 have a thickness of 1.51 cm, and a weight of about 2.51 kg/m².

The samples were used to grind an aluminum 6061 metal block with the parameters in Table 2.

TABLE 2

| Machine: | Devine | |
|---|---|---|
| Cycle time | 120 | sec. |
| Metal block | Al 6061 | |
| Load weight | 4 | Lbs, |

| Metal dimension | 3″ × 3″ × ½″ |
|---|---|
| Disc dimensions | 8 in X 1 in |
| Number of discs | 2 |
| RPM | 2700 |

The weight of the workpiece and the samples was measured after each sample to track cut rate and shed rate. Cut and shed rates relative to CS1 after 4 cycles can be found in FIG. 2. Cut and shed over time can be found in FIGS. 3a and 3b.

### Example 2

Samples 3 and CS2 were prepared according to Table 3, and the procedure outlined below.

TABLE 3

| | |
|---|---|
| Sample 3 | Sample CS2 |

Substrate

| | | |
|---|---|---|
| 60 den. Nylon w/staple length 1.5 inches | 55-65% | 55-65% |
| 15 den. Nylon w/staple length 1.5 inches | 35-45% | 35-45% |

Substrate Coating

| | | |
|---|---|---|
| Water | 55-60% | 55-60% |
| Melamine resin | 1-3% | 1-3% |
| Triton 100X | 0.05-0.2% | 0.05-0.2% |
| Nychem 1572 (Carboxyl-modified reactive | 35-40% | 35-40% |
| acrylonitrile copolymer) | | |
| colorant | 0.1-0.5% | 0.1-0.5% |

Pre-size

| | | |
|---|---|---|
| Adiprene BL-16, (Polyurethane resin) | 45-55% | 55-65% |
| Ancamine DL-50 (curative) | 2-4% | 3-5% |
| MDA (curative) | 2-4% | 3-5% |
| MIBK (solvent) | 0% | 15-25% |
| MEK (solvent) | 0% | 8-10% |
| Ethyl Levulinate | 35-45% | 0% |
| Lithium Stearate | 1-2% | 1-3% |
| Colorant | 0.5-2% | 1-2% |
| Oleic acid(catalyzer) | <0.1% | <0.1% |
| Dabco TMR (catalyzer) | <0.05% | <0.05% |
| Dabco T-12 (catalyzer) | <0.05% | <0.05% |

Binder

| | | |
|---|---|---|
| Water | 40-50% | 40-50% |
| Carbocure TRS-72 (acrylic emulsion) | 25-30% | 25-30% |
| Melamine resin | 25-30% | 25-30% |
| Triton X100 | 0.5-2% | 0.5-2% |
| 28% Ammonia | 0.5-2% | 0.5-2% |
| Colorant | 0.5-2% | 0.5-2% |

Size

| | | |
|---|---|---|
| Adiprene BL-40 (Polyurethane resin) | 52-57% | 55-60% |
| Ancamine DL-50 (curative) | 3-5% | 3-5% |
| MDA (curative) | 3-5% | 3-5% |
| MIBK (solvent) | 0 | 10-15% |
| MEK (solvent) | 0 | 7-9% |
| Ethyl Levulinate (solvent) | 20-25% | 0 |
| Talc | 4-6% | 4-6% |
| Lithium stearate | 4-6% | 4-6% |
| Cab-osil | 1-3% | 1-3% |
| Colorant | 1-2% | 1-2% |
| Oleic acid(catalyzer) | <0.2% | <0.2% |
| Dabco TMR (catalyzer) | <0.05% | <0.05% |
| Dabco T-12 (catalyzer) | <0.05% | <0.05% |

A fiber blend having a weight of about 217 g/m² was prepared having the composition in Table 2. The fiber blend was then needle punched in a needle loom to a polyester cloth to form a non-woven web. The substrate coating having the composition outlined in Table 2 was then sprayed on a first side of the non-woven web and then cured. Then, the opposite side of the nonwoven web was sprayed and cured resulting in a non-woven substrate with a weight of about 514 g/m² a width of about 1.42 m and a thickness of about 0.55 cm.

The non-woven web in samples 3 and CS2 are cut into sheets of 46×46 cm and saturated by a dip and squeeze process with the pre-size coating composition outlined above in Table 1. Abrasive grains of aluminum at an average grain size of 80 FEPA P grade are dropped by gravity on one side of the saturated non-woven web at about 813 g/m². After that, an abrasive binder having the composition in Table 2 is sprayed on the side. The samples were cured in an electrical batch oven for 12 minutes at 325° F. The presize coated samples 3 and CS2 have a thickness of 0.8 cm, and a weight of about 1.51 kg/m².

The presize coated samples 3 and CS2 were saturated by a dip and squeeze process with the size coating composition outlined above in Table 2. The samples were in an electrical batch oven for 30 minutes at 325° F. The size coated samples 3 and CS2 have a thickness of 0.8 cm and a weight of about 2.25 kg/m².

Sample 3 and sample CS2 were evaluated for cut and shed rate. Sample 3 performed comparably to sample CS2 while using a more ecologically friendly solvent.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. An abrasive article precursor comprising:
a substrate:
an abrasive layer comprising abrasive particles and a binder;
wherein the abrasive layer comprises 5-50 wt % of, an eco-solvent;
wherein the eco-solvent comprises:
d-limonene; l-limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.

2. The abrasive article precursor of claim 1, wherein the substrate comprises a nonwoven material.

3. The abrasive article precursor of claim 1, wherein the substrate comprises nylon fibers.

4. The abrasive article precursor of claim 1, wherein the abrasive particles comprise alumina.

5. The abrasive article precursor of claim 1, wherein the eco-solvent comprises ethyl levulinate, d-limonene, l-limonene, dipentene, or a combination thereof.

6. The abrasive article precursor of claim 1, wherein the eco-solvent comprises a flash point of at least 100° F. and less than 300° F.

7. The abrasive article precursor of claim 1, wherein the binder is essentially free of methyl ethyl ketone.

8. The abrasive article precursor of claim 1, wherein the eco-solvent comprises a boiling point of at least 300° F. and less than 480° F.

9. The abrasive article precursor of claim 1, wherein the binder is essentially free of MIBK.

10. An abrasive article comprising:
a substrate:
an abrasive layer comprising abrasive particles and a binder;
wherein the abrasive layer comprises an eco-solvent;
wherein the eco-solvent comprises:
d-limonene; l-limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.

11. The abrasive article of claim 10, wherein the substrate comprises a nonwoven material.

12. The abrasive article precursor of claim 10, wherein the substrate comprises nylon fibers.

13. The abrasive article of claim 10, wherein the abrasive particles comprise alumina.

14. The abrasive article of claim 10, wherein the eco-solvent comprises ethyl levulinate, d-limonene, l-limonene, dipentene, or a combination thereof.

15. The abrasive article precursor of claim 10, wherein the eco-solvent comprises a flash point of at least 100° F. and less than 300° F.

16. The abrasive article precursor of claim 10, wherein the binder is essentially free of methyl ethyl ketone.

17. The abrasive article precursor of claim 10, wherein the eco-solvent comprises a boiling point of at least 300° F. and less than 480° F.

18. The abrasive article precursor of claim 10, wherein the binder is essentially free of MIBK.

19. A method of using the abrasive article of claim 10 to grind or polish a workpiece.

20. A method of making an abrasive article comprising:
providing a substrate:
depositing an abrasive layer precursor over the substrate, the abrasive layer comprising abrasive particles and a binder; and
curing the abrasive layer precursor to form an abrasive layer,
wherein the abrasive layer precursor comprises 5-50 wt % of, an eco-solvent;
wherein the eco-solvent comprises:
d-limonene; l-limonene; dipentene; methyl dodecanoate; methyl octanoate; 1,3 propanediol; ethyl lactate; ethyl levulinate; levulinate propanediol ketal; isopropylidene glycol; butyl levulinate; propylene carbonate; or a combination thereof.
